(19) United States
(12) Patent Application Publication
(10) Pub. No.: US 2010/0193548 A1
(43) Pub. Date: Aug. 5, 2010

(54) Personal powder dispenser

(76) Inventors: Stanley J. Poreda, Bristol, RI (US); David R. Harris, Sterling, MA (US)

Correspondence Address: Stanley J. Poreda, 37 Brook Farm Drive, Bristol, RI, 02809, US

(21) Appl. No.: 12/660,915

(22) Filed: Mar. 8, 2010

(51) Int. Cl. G01F 11/10

(52) U.S. Cl. 222/365

(57) ABSTRACT

A powder dispenser includes: a casing enclosing a powder reservoir and having a dispensing port; a powder ram slidably mounted within the casing between an initial position, an intermediate position and a final position, the powder ram including a dispensing end that moves through the powder reservoir as the powder ram moves from its initial position to its intermediate position; a metering chamber formed as the powder ram reaches its intermediate position, the metering chamber receiving powder as the powder ram moves from its initial position to its intermediate position; a powder barrier having a closed position and an open position, while in its closed position the powder barrier preventing the escape of powder through the dispensing port, the powder barrier moving from its closed position to its open position as the powder ram moves from its intermediate position to its final position, the powder ram forcing powder contained in the metering chamber out of the dispenser and through the dispensing port as the powder ram moves from its intermediate position to its final position.

### BACKGROUND OF THE INVENTION

The present invention relates to a hand-held and hand-operated powder dispenser capable of repeatedly dispensing minute controlled amounts of a dry powder.

A hand-held and hand-operated powder dispenser that is capable of repeatedly dispensing minute controlled amounts of a dry powder has a number of potential applications. These include dispensing mixture additives, condiments, flavorings, sweeteners, and nutritional supplements. For example, the widely used sweetener trichlorosucrose is approximately six hundred times as sweet as ordinary sugar and yet there are no hand-held dispensers capable of dispensing the pure powder in the amounts commonly used. A hand-held and hand-operated dispenser would be more convenient than using paper packets that contain unwanted fillers; and a dispenser that is also inexpensive could be more economical than using costly packets. Configuring such a dispenser as a pen-like device that can be carried in a shirt pocket or pocket book and that can be operated with one hand would increase its appeal. Such a personal dispenser will preferably be inexpensive and disposable. An inexpensive dry powder dispenser suitable for table-top or counter-top use would also be desirable.

Many powder dispensers have been disclosed and these disclosures teach that powder dispensers typically possess a number of common features including a powder reservoir, a metering chamber and a means for moving powder from the powder reservoir into this chamber, a powder barrier that when in the closed position prevents powder from escaping the dispenser, and a means by which this powder barrier can be opened and closed; and finally, a means for moving powder, contained in the metering chamber, out of the dispenser while the powder barrier is its open position.

Handling minute amounts of dry powders, with volumes in the range of 0.5-25 mm³, poses a difficult challenge without the aid of special powder handling equipment. Small amounts of a powder may cling to surfaces and/or become agglomerated due to molecular forces, hydroscopic action or static electrical effects. These properties preclude the use of powder dispensers that depend on gravity to move powder into the metering chamber and then out of the chamber and the dispenser. U.S. Pat. Nos. 4,811,869 and 5,855,300, and pending US patent 2009/0065092A1 are only three of many disclosures that teach of such dispensers. U.S. Pat. No. 6,871,758 and commercially available dispensers, e.g., Powder Pipetter made by San Diego Scientific Instruments of Poway Calif., use compressed gas and/or a vacuum to move dry powder from a reservoir to a metering chamber and then use compressed gas to move that powder out of the chamber and the dispenser. While providing dependable performance and the capability to dispense minute amounts of powder, these expensive dispensers are bench-top or production line devices that are not portable and not suitable for personal use.

U.S. Pat. No. 6,871,758 assigned to the Schering Corporation is of particular interest since its novel features are an indication of the difficulty involved in dispensing minute amounts (0.1-20 mm³) of powder. It teaches of a multi-step dispensing method that first uses compressed gas to swirl powder contained in a powder reservoir and then makes use a vacuum to suck powder into a metering chamber. This requires the use of a porous frit that allows the passage of gas but not of powder. This method requires use of compressed gas to move powder contained in the metering chamber out of the dispenser and it further requires use of a vacuum source to remove compressed gas and residual powder proximal to the metering chamber. The Schering method does not however provide a means for rapidly adjusting the amount of powder to be dispensed.

The principal challenge that must be overcome in designing an inexpensive and personal powder dispenser for dispensing minute portions of a dry powder is in providing a reliable means for moving a controlled amount of powder from the powder reservoir into the metering chamber and then out of the metering chamber and the dispenser.

Sekiguchi et al in U.S. Pat. No. 4,906,120 teach of a powder dispenser containing a spiral member that moves small portions of powder out of a dispenser and into an attached brush. While this invention provides a solution to the problem of deagglomerating powder contained in the reservoir and moving small portions of powder from a dispenser, the device in not capable of accurately controlling the amount of powder that is dispensed and it appears prone to powder leakage. While these drawbacks may be of little concern for cosmetic dispensers, they preclude other aforesaid applications for the invention.

Malki, in U.S. Pat. No. 5,855,300, teaches of a hand-held powder dispenser. This novel device is comprised of a powder reservoir, a metering chamber, and an actuator, that when actuated, causes the metering chamber to move. Powder flows into the metering chamber by force of gravity while the actuator is not actuated and while the device is vertically oriented. Following actuation, the metering chamber moves so as to prevent additional powder from entering the chamber from the powder reservoir and so as to allow powder, contained in the chamber to escape from the bottom of the device by force of gravity. With this dispenser, the powder barrier is fixed and its function is dictated by the position of the moveable metering chamber. This invention is intended for dispensing a controlled portion of powder of an amount that is in the teaspoon (about 5000 mm³) range and because it depends on the force of gravity to move the powder, it is not be suitable for dispensing minute amounts (25 mm³ or less) of powder.

U.S. Pat. Nos. 4,723,691 and 5,082,148 teach of a handheld and hand powered powder dispensers that operate through the expulsion of air from the device. Both inventions comprise a mixing chamber where air and powder are mixed before being expelled from the dispenser. These inventions are not suitable for dispensing the aforesaid minute amounts of powder nor are they capable of controlling the amount of powder that is dispensed with each dispensing action.

U.S. Pat. No. 4,467,656 teaches of a hand held powder dispenser with a closure ball and a valve seat that together serve as a powder barrier. As the device is accelerated the closure ball moves away from the valve seat and allows powder to escape from the dispenser. This invention is not suitable for dispensing the aforesaid minute amounts of powder nor is it capable of controlling the amount of powder that is dispensed with each dispensing action.

Some powders can be formed into pellets, possibly with the addition of a binder and/or filler. Small pellets are easier to handle than an equivalent amount of powder and inventions have been disclosed that dispense one or a small number of such pellets with each dispensing action. For example U.S. Pat. No. 4,831,998 teaches of an invention that dispenses a single pellet for each dispensing action. Powders could also be packaged in capsules or blister packets each containing the desired powder portion. U.S. Pat. No. 6,591,832 B1 teaches of a powder dispenser using rupturable pillows of dry powder. Such devices have no need for a powder reservoir or a metering chamber or a means for moving powder from the reservoir and into the metering chamber. However these devices have the serious drawback that they require a source of pellets, capsules or blister packets. This will necessarily increase the cost of using the dispenser and will reduce the number of dispensing portions that can be stored in the dispenser. In all cases, these pellets, capsules or blister packets would have to be manufactured expressly for use in such a dispenser.

U.S. Pat. Nos. 6,119,688 and 6,029,661 teach of powder dispensers containing powder deagglomerators and metering mechanisms. These inventions utilize a rotating mechanism that requires the use of two hands to operate and that results in a bulky device. In addition, these inventions are intended for use as inhalers, and the flow of air caused by the inhalation of a patient is used to move the metered powder from the device and into the patients breathing passage. Such dispensers are not suitable for dispensing minute amounts of powder into ordinary receptacles.

Powdered substances that can be dissolved in water or another suitable solvent without deleterious effects can be accurately dispensed with a dropper-bottle device. However, these devices generally require two hands to operate, they are susceptible to spills, and they are not suitable to be carried about in a shirt pocket or in a pocket book. Their bulkiness and the risk of breakage or leakage add to their lack of appeal. Use of a dropper bottle to dispense a solution of trichlorosucrose has an added disadvantage that the concentrated solution crystallizes easily and makes it difficult to unscrew the dropper from the bottle.

In order to meet the challenge of dispensing minute amounts of a dry powder using an inexpensive hand-held and hand-operated device, and without resorting to the use of dropper-bottles, pellets, capsules, or blister packets, a novel powder dispenser and powder dispensing method are disclosed. The disclosed powder dispenser can be constructed of inexpensive materials and configured as a disposable pen-like device. This innovative powder dispenser is comprised of a casing with a dispensing port and an associated powder barrier that has an open and a closed position. Enclosed in the casing is a powder reservoir and a powder ram. In addition, the powder dispenser comprises one or more actuators that are actuated by operator action. With each operator initiated dispensing action, the powder ram passes through the powder reservoir. This action has the three-fold purpose of deagglomerating the powder in the powder reservoir, forming a metering chamber and forcing powder into that formable metering chamber. In addition to the powder ram, this metering chamber is formed by the powder barrier and the interior walls of the dispenser. Prior to an operator initiated dispensing action, the moveable powder barrier is in its closed position and blocking the dispensing port thereby preventing the escape of powder from the dispenser. As the metering chamber is being formed, powder is forced into it by the powder ram. The powder barrier is then caused to move to its open position and to thereby allow powder to escape from the metering chamber and the dispenser. As the dispensing process proceeds, the powder ram forces the powder, formerly contained in the metering chamber out of the powder dispenser through the dispensing port. The powder ram also acts to prevent additional powder from escaping from the powder reservoir during the dispensing process. Upon release of at least one actuator by the operator, the powder ram returns to its initial position and the powder barrier returns to its closed position. The powder dispenser is then ready to release another portion of powder upon an operator initiated dispensing action.

In a preferred embodiment the dispensing end of the powder ram is fixedly connected to one end of an attaching member of reduced cross section. The opposing end of this attaching member is fixedly attached to the powder barrier. The powder ram, the attaching member and the powder barrier thereby form a ram-barrier assembly. The dispensing end of the powder ram and attaching member form a shoulder that moves through the powder reservoir until the powder ram reaches an intermediate position at which point the ram-barrier assembly and inner walls of the casing form the metering chamber. As the powder ram moves from its initial position to the intermediate position this shoulder forces powder from the powder reservoir into the forming metering chamber. As the ram assembly moves beyond its intermediate position the powder barrier moves to its open position and the shoulder forces the powder that was contained in the metering chamber out of the dispensing port of the powder dispenser. The preferred embodiment is additionally comprised of a gas container and a gas valve. The gas valve allows gas to travel from the gas container to a plurality of gas channels in the powder ram. These channels terminate at a plurality of outlet ports on the shoulder formed by the dispensing end of the powder ram and the attaching member. As the powder ram reaches its final position in the dispensing action, a burst of gas is released from the gas container by the gas valve. As this burst of gas passes out the outlet ports on the shoulder, the powder that is proximal to the dispensing end of the dispenser will be disengaged and propelled away from the dispenser.

The volume of the formable metering chamber of the preferred embodiment is made adjustable by providing a threaded connection between the attaching member and the powder ram. This provides a capability to rapidly adjust the amount of powder dispensed with each dispensing action.

In another embodiment of the disclosed powder dispenser, the powder ram is comprised of a powder ram assembly comprising a rod disposed within a sleeve. This powder ram assembly is aligned with the central axis of a formable metering chamber and the rod has a cross section that allows it to pass through the sleeve and past the walls of the formable metering chamber. At the start of the dispensing action, the dispensing end of the powder ram assembly forms a recess that deagglomerates the powder contained in the powder reservoir as it moves through the powder reservoir. This recess accumulates an amount of powder that is forced into the metering chamber by the powder ram assembly. At an intermediate position the powder ram assembly forms one end of the metering chamber while the powder barrier forms an opposing end. As the dispensing action proceeds, the powder barrier moves to its open position, the movement of the sleeve is halted and the rod continues to move past the walls of metering chamber thereby forcing substantially all the powder that was therein contained out of the powder dispenser through the dispensing port.

The leading end of the sleeve may be fashioned and/or operated so as to facilitate both the capture and the deagglomeration of the powder contained in the powder reservoir. In one embodiment, the end of the sleeve is tapered to yield a fine edge. As this edge passes through the powder reservoir, agglomerations of powder are broken up. In another embodiment, the end of the tubular sleeve is serrated. As this edge passes through the powder reservoir, agglomerations of powder will be engaged and then broken up as they are moved within proximity of the metering chamber. In still another embodiment, the sleeve is caused to rotate about a central axis thereby boring through and breaking up agglomerations of powder within the powder reservoir.

The disclosed powder dispenser and powder dispensing method makes possible a means by which a minute controlled amount of a powder contained in a powder reservoir can be forced into a formable metering chamber and then forced out of the powder dispenser. The resulting powder dispenser can be configured as an inexpensive and disposable hand-held and hand-operated device or alternately as a tabletop or countertop device suitable for use in a kitchen or a commercial establishment.

### DESCRIPTION OF THE DRAWINGS

FIG. 1 is a lengthwise cross section of a preferred embodiment of a powder dispenser at the initial state in the dispensing action;

FIG. 2 is a lengthwise cross section of the preferred embodiment of a powder dispenser at an intermediate state in the dispensing action;

FIG. 3 is a lengthwise cross section of the preferred embodiment of a powder dispenser at the final state in the dispensing action;

FIG. 4 is a lengthwise cross section of the ram-barrier assembly that comprises the preferred embodiment of a powder dispenser;

FIG. 5 is an elevated view of the dispensing end of the ram-barrier assembly that comprises the preferred embodiment of a powder dispenser;

FIG. 6 is a cross section of one embodiment of the dispensing end of the ram-barrier assembly that comprises the preferred embodiment of a powder dispenser;

FIG. 7 is an action drawing of the preferred embodiment of the powder dispenser.

### OBJECTS OF THE INVENTION

It is an object of the present invention to provide an inexpensive hand-held and hand-operated powder dispenser capable of repeatedly dispensing minute and controlled amounts of a dry powder.

It is another aspect of the present invention to provide an inexpensive countertop powder dispenser, suitable for use in a kitchen or a commercial establishment, and capable of repeatedly dispensing minute controlled amounts of a dry powder.

### SUMMARY OF THE INVENTION

These and other objects are achieved in a novel and innovative powder dispenser and powder dispensing method. The disclosed powder dispenser is comprised of a casing with a dispensing port and an associated powder barrier that has an open and a closed position. The casing encloses a powder reservoir holding a supply of powder and a slidably disposed powder ram with a dispensing end; the dispensing end of the powder ram moving from an initial position, through the powder reservoir, and toward the dispensing port with each dispensing action; the dispensing end of the powder ram deagglomerating powder in the powder reservoir as it moves to an intermediate position; the dispensing end of the powder ram also forcing powder from the powder reservoir and into a formable metering chamber that is formed as the dispensing end of the powder ram reaches its intermediate position; the formable metering chamber having a volume substantially equal to the volume of the amount of powder dispensed with each dispensing action; the powder ram preventing additional powder contained in the powder reservoir from escaping from the powder dispenser after the dispensing end of the powder ram reaches its intermediate position and before returning to its initial position. The powder barrier while in the closed position preventing powder from escaping from the dispenser through its dispensing port; the powder barrier moving from the closed position to the open position after the dispensing end of the powder ram has reached its intermediate position, thereby allowing powder to escape from the dispenser through its dispensing port. The dispensing end of the powder ram forcing the powder that was contained in the formable metering chamber through the dispensing port and out of the dispenser as the powder ram moves from the intermediate position to a final position. The dispensing end of the powder ram returning to its initial position and the powder barrier returning to its closed position at the completion of a dispensing action.

In accordance with a preferred embodiment of the present invention the powder ram and the powder barrier comprise a ram-barrier assembly which is provided by fixedly attaching, to the dispensing end of the powder ram, an attaching member of reduced cross section, and by fixedly attaching the opposing end of this attaching member to the powder barrier; the dispensing end of the powder ram and the attaching member forming a shoulder that deagglomerates powder in the powder reservoir and moves powder from the powder reservoir toward the dispensing port as the powder ram moves from its initial position to its intermediate position; the ram-barrier assembly and interior walls of the casing forming a metering chamber as the powder ram reaches its intermediate position; and as the powder ram moves from its intermediate position to its final position, the shoulder moving past the walls of the metering chamber toward the dispensing port thereby forcing the powder that was previously contained in the metering chamber through the dispensing port and out of the dispenser. The preferred embodiment is additionally comprised of a gas container, a gas valve, and a means by which the gas contained in the gas container is compressed. The gas valve communicates with the gas container and a plurality of gas channels disposed within the powder ram; these gas channels terminating at a plurality of outlet ports on the shoulder formed by the dispensing end of the powder ram and the attaching member, the gas valve releasing a burst of gas that passes through the gas channels to exit at the outlet ports as the powder ram reaches its final position thereby disengaging powder from the shoulder and disengaging powder that is otherwise proximal to the dispensing port.

The present invention provides a means by which trichlorosucrose powder can be dispensed in teaspoon equivalent amounts (about 7 mm³) and in a pure form without the need for bulking agents and without specialized packaging.

The present invention also provides a means by which a powder dispenser capable of dispensing minute amounts of a dry powder can be configured as a pen-like hand-held and hand-operated device constructed of inexpensive plastic parts and commercially available springs, gaskets, o-rings and fasteners.

The present invention further provides a means by which a tabletop powder dispenser capable of dispensing minute amounts of a dry powder can be configured as a salt-shaker-like device that, when in use, is hand-held and hand-operated and that is constructed of inexpensive plastic parts and commercially available springs, gaskets, o-rings and fasteners.

The present invention still further provides a means by which a countertop powder dispenser, suitable for use in kitchens and commercial establishments, can be configured without requiring separate gas and/or vacuum sources.

### DETAILED DESCRIPTION

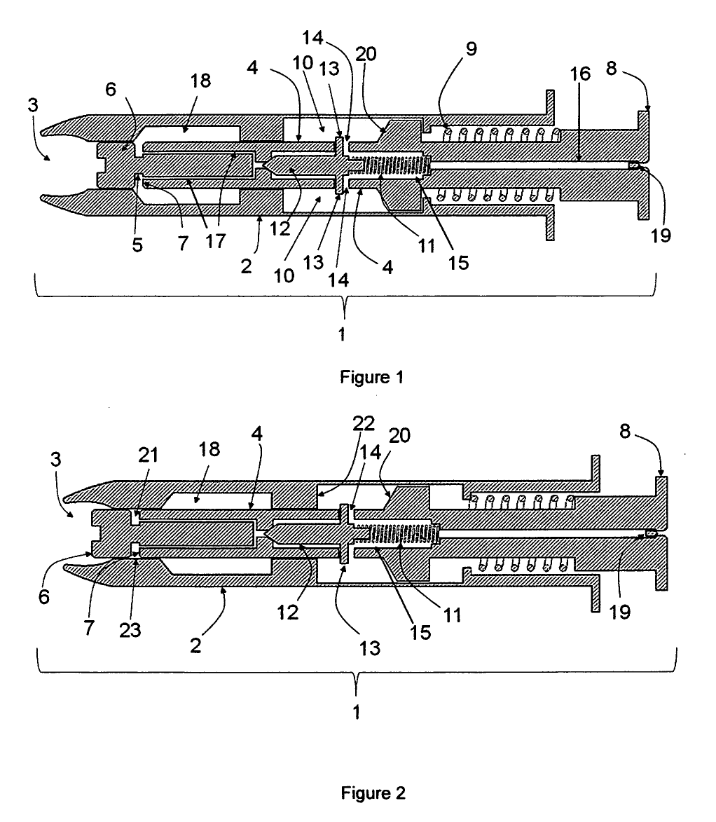

Referring to FIG. 1, a lengthwise cross section of a preferred embodiment of a powder dispenser 1 is depicted. The powder dispenser 1 comprises a casing 2, with a dispensing port 3. In this embodiment a ram-barrier assembly (FIG. 4), comprising a powder ram 4, a attaching member 5, and a powder barrier 6, is slidably disposed within the casing 2 and aligned with the central axis of the casing 2. A shoulder 7 is formed by the dispensing end of the powder ram 4 and the attaching member 5. An actuator 8 fixedly attached to the powder ram 4 is opposed by a first spring 9. The depicted powder dispenser 1 also comprises a toroidal gas piston 20 fixedly attached to the powder ram 4, a gas container 10, a valve spring 11 and a gas valve 12. Fixedly attached to the gas valve 12 are two valve pins 13 that protrude through two valve pin slots 14 in the wall of the powder ram 4. The gas valve 12 and associated valve spring 11 are disposed within a valve recess 15 in the powder ram 4. The valve recess 15 is aligned with the central axis of the powder ram 4 and communicates with an intake channel 16 and with a plurality of gas channels 17. The valve recess 15 also communicates with the gas container 10 via the two valve pin slots 14 thereby allowing the free flow of air from the gas container 10 to the valve recess 15. In FIG. 1 the powder ram 4 is depicted in its initial position, the powder barrier 6 is depicted in its closed position, and the gas valve 12 is depicted in its closed position. In this state the powder barrier 6 prevents the escape of powder from the powder reservoir 18 through the dispensing port 3 and powder contained in the powder reservoir 18 is free to enter the space bounded by the shoulder 7, the attaching member 5 and the powder barrier 6. When the actuator 8 is depressed the gas piston 20 will move inside the casing 2 toward the dispensing port 3 thereby compressing the air contained in the gas container 10 and the valve recess 15. At the stage depicted in FIG. 1, escape of the gas contained in the gas container 10 and the valve recess 15 is prevented by the gas valve 12 and a one-way valve 19.

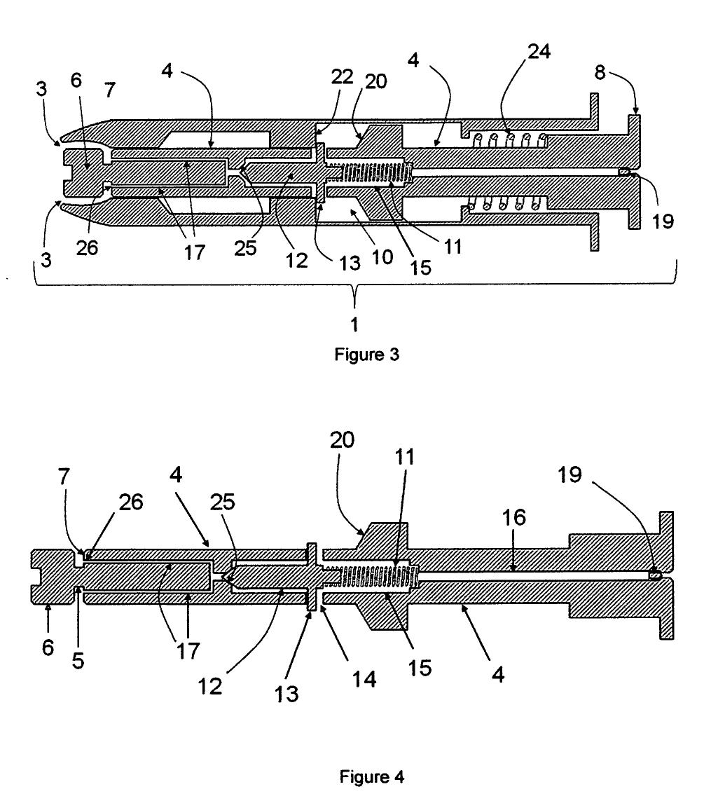

Referring now to FIG. 2, the powder dispenser 1 is depicted in a state wherein the powder ram 4 is in its intermediate position and the gas valve 12 is in its closed position. In comparison to FIG. 1, the shoulder 7 has moved in the direction of the dispensing port 3 to a point where its outer edge is in contact with an inner wall 23 of the casing 2. At this point the shoulder 7, the inner wall 23 of the casing 2, the powder barrier 6 and, the attaching member 5 have formed a toroidal metering chamber 21. Also at this point the piston 20 has moved toward the dispensing port 3 thereby compressing the air contained in the gas container 10 and the valve recess 15. As the actuator 8 is further depressed from its position as depicted in FIG. 2, the shoulder 7 will force the powder contained in the metering chamber 21 toward the dispensing port 3. At the stage depicted in FIG. 2 and as the actuator 8 is further depressed the powder ram 4 will prevent any additional powder contained in the powder reservoir 18 from escaping through the dispensing port 3, the ram-barrier assembly and the gas valve 12 will continue to move in the direction of the dispensing port 3. Immediately prior to the powder ram 4 reaching its final position the movement of the valve pins 13 and the valve 12 towards the dispensing port 3 will be halted as the protruding ends of the valve pins 13 engage a stop 22 that is fixedly attached to the inside of the casing 3. This will compress the valve spring 11 and cause the gas valve 12 to move to its open position as depicted in FIG. 3.

FIG. 3 is a lengthwise cross section of the preferred embodiment of the powder dispenser 1. This figure depicts the powder ram in its final position; the powder barrier 6 is in its open position; and the gas valve 12 is in its open position. At this stage the powder that was in the formable metering chamber 21 is free to exit the powder dispenser through the dispensing port 3. Immediately prior to reaching this state the gas valve 12 is caused to move to its open position causing compressed gas contained in the gas container 10 to escape past the gas valve 12 and the valve seat 25, then through a plurality gas channels 17 and out the outlet ports 26 located on the shoulder 7. This cross section indicates the presence of at least two gas channels 17 terminating at two outlet ports 26. The preferred embodiment will preferably comprise at least six gas channels 17 and six corresponding outlet ports 26. The movement of gas through the outlet ports 26 will disengage powder proximal to the shoulder 7 and force that powder out of the dispenser through the dispensing port 3. Following the discharge of gas and powder from the powder dispenser 1 and following release of the actuator 8, the first spring 24 will cause the powder ram 4 to return to its initial position and the powder barrier 6 to return to its closed position; in addition the valve spring 11 will cause the gas valve 12 to return to its closed position as the valve pins 13 lose contact with the valve pin stop 22; and the one-way valve 19 will allow air to enter the gas container 10.

FIG. 4 is a lengthwise cross section of the ram-barrier assembly that comprises the preferred embodiment. A one-way valve 19 allows air to enter but not escape from the intake channel 16 which communicates with the valve-spring recess 15. Regardless of the position of the valve pins 13, the valve pin slots 14 communicate with the gas container 10 (not shown in FIG. 4) and with the valve-spring recess 15. While the gas valve 12 is in its closed position as depicted in FIG. 4 it is in contact with the valve seat 25 thereby preventing gas from escaping from the valve-spring recess 15 and the gas container 10 through the gas channels 17 and out through the outlet ports 26. Upon moving to its open position, the gas valve 12 will lose contact with the valve seat 25 thereby allowing gas to escape through the gas channels 17 and out through the outlet ports 26.

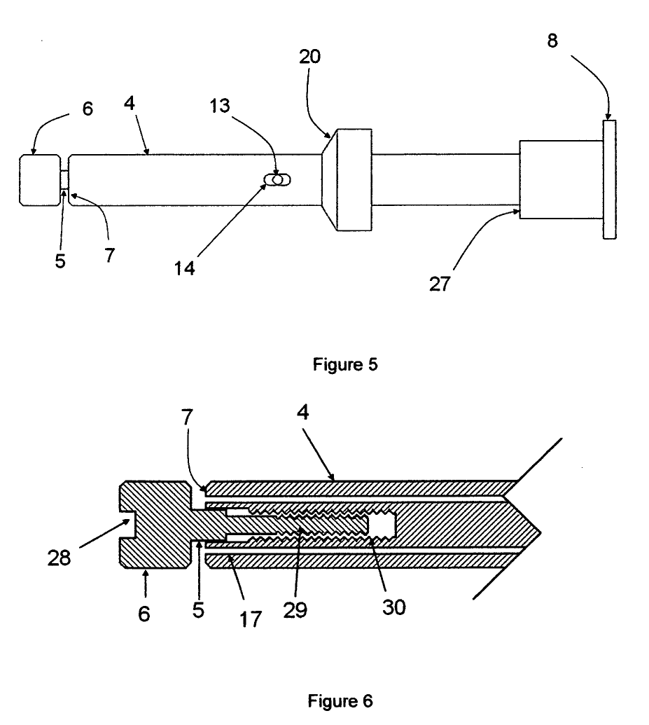

Referring now to FIG. 5, an elevated view of the ram-barrier assembly and the exterior end of one of two valve pins 13 that comprise the preferred embodiment is depicted. One valve pin 13 is seen protruding from one of two valve pin slots 14 in the wall of the powder ram 4. Also depicted is a first spring stop 27, the actuator 8, the piston 20, and the attaching member 5: each fixedly attached to the powder ram 4. The attaching member 5 together with the powder ram 4 forms the shoulder 7. The attaching member 5 is also fixedly attached to the powder barrier 6.

FIG. 6 is a cross section of one possible embodiment of the dispensing end of the ram-barrier assembly that comprises the preferred embodiment. In this embodiment, the powder barrier 6 and the connecting member 5 comprise an adjusting screw having a threaded end 29. The threaded end 29 of this adjusting screw is received by a threaded receptacle 30 aligned with the central axis of the powder ram 4. The adjusting screw is advanced or retracted relative to the powder ram 4 by turning the adjusting screw using a tool applied to a tool receptacle 28 in the powder barrier 6. The tool receptacle can be fashioned to accept a screw driver, an Allen Wrench, or a similar tool. Turning the adjusting screw will increase or decrease the distance between the shoulder 7 and the powder barrier 6 thereby increasing or decreasing the volume of the formable metering chamber 21 (see FIG. 2). This will serve to increase or decrease the amount of powder that is dispensed by the powder dispenser 1 with each dispensing action.

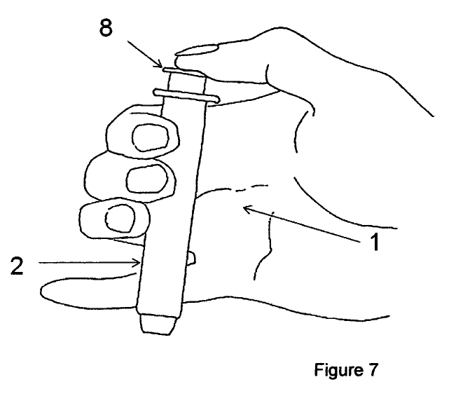

FIG. 7 is an elevated view of the preferred embodiment 1 of the powder dispenser and a hand. This figure depicts one possible way in which the powder dispenser 1 could be operated while being held in one hand: the casing 2 of the powder dispenser 1 is held between the fingers and the palm of the hand and the powder dispenser 1 is operated by depressing the actuator 8 with the thumb of the hand.

This disclosed powder dispenser and powder dispensing method provide a means for dispensing minute amounts of a range of dry powders. The amount of powder dispensed with each dispensing action can be controlled to yield a nominal portion in the 0.5-20 mg range with a sample deviation of less than 10%. Hydroscopic powders can be maintained for long periods by virtue of the air-tight design of the dispenser and the incorporation of drying agents.

The disclosed powder dispenser and powder dispensing method can be implemented as an inexpensive and disposable hand held device containing sufficient powder to supply hundreds of minute controlled portions of powder. Such a powder dispenser can be configured as a pen-shaped and pen-sized device that can be carried in a shirt pocket or a pocketbook. The device can also be implemented as an inexpensive and disposable salt shaker-like device for use at the table or in the kitchen. The device can additionally be implemented as a refillable countertop device suitable for use in restaurants, coffee shops, or manufacturing establishments.

Having described in detail one specific embodiment of the invention with reference to the accompanying drawings, it will be appreciated that the present invention is not limited to that precise embodiment and that various changes and modifications can be effected therein by one of ordinary skill in the art without departing from the scope or spirit of the invention as defined by the appended claims.

We claim:

1. A powder dispenser for dispensing a controlled amount of a powder with each operator initiated dispensing action and comprising:
a casing, with a dispensing port;
said casing enclosing a powder reservoir holding an amount of powder sufficient for a plurality of dispensing actions;
a plurality of actuators that are actuated and/or released individually or in concert as part of said operator initiated dispensing action, preferably requiring the use of only one hand;
a powder barrier, having an open position and a closed position, that communicates with at least one said actuator;
while in the closed position said powder barrier substantially preventing the escape of any powder from said powder dispenser through said dispensing port;
a powder ram slidably disposed within said casing and having an initial position, an intermediate position, and a final position;
said powder ram communicating with at least one said actuator and having a dispensing end;
said powder ram being caused to move from its initial position to its intermediate position, and then to said final position upon an operator initiated dispensing action;
a metering chamber that is formed by the dispensing end of said powder ram while it is in its intermediate position, and by interior walls of said casing, and by said powder barrier while it is in its closed position;
the dispensing end of said powder ram moving through said powder reservoir as said powder ram moves from its initial position to its intermediate position so as to force powder ahead of the dispensing end of said powder ram and in the direction of said dispensing port;
as said powder ram reaches its intermediate position, powder forced out of said powder reservoir by the dispensing end of said powder ram substantially filling the metering chamber that is simultaneously formed;
following the formation of said metering chamber, said powder barrier being caused to move to the open position upon actuation of at least one said actuator;
said powder barrier while in its open position allowing powder contained in said metering chamber to exit said metering chamber through said dispensing port;
in concert with said powder ram moving from its intermediate position to its final position the dispensing end of said powder ram moving toward said dispensing port thereby forcing the powder, that had been contained in the metering chamber, out of the dispenser;
said powder ram substantially preventing additional powder from leaving said powder reservoir after said powder ram reaches its intermediate position and before returning to its initial position;
said powder barrier returning to its closed position and said powder ram returning to its initial position upon the release of at least one actuated actuator.

2. The invention of claim 1 wherein said powder ram is comprised of a rod-sleeve assembly;
said rod-sleeve assembly comprising a sleeve having a dispensing end, and also comprising a rod having a dispensing end,
a central axis of said sleeve and a central axis of said rod being substantially aligned with each other and with a central axis of said metering chamber;
said rod partially disposed within said sleeve and capable of traveling some distance, relative to said sleeve, along the central axis of said sleeve;
said rod and said sleeve being oriented so that said rod substantially occupies the interior of said sleeve when the dispensing end of said rod is aligned with the dispensing end of said sleeve;
said rod having a cross section allowing the dispensing end of said rod to move past the interior walls of the casing that form said metering chamber and then through said dispensing port with each operator initiated dispensing action;
while said powder ram is in its initial position, the position of the dispensing end of said sleeve being advanced relative to the position of the dispensing end of said rod, in the direction of the dispensing port, so as to create a receptacle capable of capturing an amount of powder as said powder ram moves through said powder reservoir;

3. The invention of claim 1 wherein said powder ram and said powder barrier comprise a ram-barrier assembly that also comprises a member fixedly attaching said powder ram and said powder barrier and having a cross section less than that of said powder ram:
said powder ram and said attaching member forming a shoulder that passes through said powder reservoir as said powder ram moves from its initial position to its intermediate position thereby deagglomerating powder contained in said reservoir and forcing powder in the direction of said dispensing port;

4. The invention of claim 1 wherein a plurality of parts of said powder dispenser that, in the operation of said powder dispenser, come into contact with the powder to be dispensed, are manufactured of a material, or coated with a material, that resists adherence or prevents agglomeration of said powder.

5. The invention of claim 1 wherein said powder dispenser is provided with an openable loading port through which powder is transferred to or from said powder reservoir for the purpose of refilling said powder dispenser or for the purpose of emptying the contents of said powder dispenser.

6. The invention of claim 1 wherein said powder dispenser is not refillable,

7. The invention of claim 1 wherein the volume of said metering chamber is adjustable in response to the actuation of at least one said actuator;
said adjusting actuator communicating with a graduated scale indicating the relative volume of said metering chamber;

8. The invention of claim 1 wherein a plurality of deagglomerating objects being located within said powder reservoir, are free to move to some degree within said powder reservoir so as to deagglomerate the powder therein contained in response to an acceleration is imparted on said powder dispenser.

9. The invention of claim 1 wherein said sleeve is caused to rotate about its central axis as it moves from its initial position to its intermediate position so as to more effectively accumulate and deagglomerate powder as it moves through said powder reservoir.

10. The invention of claim 1 wherein said powder ram is caused to move by means of an electromagnetic device, following actuation of at least one said actuator or release of at least one actuated said actuator.

11. The invention of claim 1 wherein said powder barrier is caused to move by means of an electromagnetic device, following actuation of at least one said actuator or release of at least one actuated said actuator.

12. The invention of claim 1 wherein said powder dispenser additionally comprises a gas container containing pressurized gas;
said powder dispenser being provided with a means for pressurizing gas contained in said gas container;
said powder ram comprising a plurality of gas channels extending to a plurality of outlet ports located on the dispensing end of said powder ram;
said gas channels of said powder ram communicating with a gas valve having an open position and a closed position;
said gas valve communicating with at least one said actuator and also communicating with said gas container;
said gas valve being in closed position while said powder ram is in its initial position;
said gas valve moving from its closed position to its open position through the action of at least one said actuator as said powder ram moves from its intermediate position to its final position thereby causing compressed gas to flow from said gas container through said gas valve and through said gas channels to exit from said outlet ports thereby disengaging powder, proximal to the dispensing end of said powder ram;
while in its open position, said gas valve returning to its closed position upon release of at least one actuated actuator.

13. A powder dispensing method, having operating states equal to “initial” and “dispensing”, and comprising:
storing powder of an amount sufficient for a plurality of controlled amounts of powder:
actuating at least one actuator;
selectively containing said stored powder:
transitioning said operating state from initial to dispensing in response to actuation of at least one actuator:
deagglomerating said stored powder in response to operator actions that are not limited to actuating at least one actuator:
forming a metering chamber, having a volume that is substantially equivalent to the amount of powder comprising one said controlled amount of powder, in response to actuation of at least one actuator:
moving an amount of said stored powder substantially equivalent to the amount of powder comprising one said controlled amount of powder, into said formable metering chamber in response to actuation of at least one actuator:
removing containment for powder contained in said metering chamber while maintaining containment of stored powder that is not in said metering chamber in response to actuation of at least one actuator:
forcing powder out of said metering chamber, in response to actuation of at least one actuator:
transitioning operating state from dispensing to initial in response to the release of at least one actuator.
